(19) United States
(12) Patent Application Publication
(10) Pub. No.: US 2019/0068016 A1
(43) Pub. Date: Feb. 28, 2019

(54) MULTIPOLE ROTOR WITH LOAF-SHAPED OR PIECE-OF-CAKE-LIKE PERMANENT MAGNETS

(71) Applicant: Lakeview Innovation Ltd., Buochs (CH)

(72) Inventor: Jens Schulze, Giswil (CH)

(73) Assignee: Lakeview Innovation Ltd., Buochs (CH)

(21) Appl. No.: 16/116,214

(22) Filed: Aug. 29, 2018

(30) Foreign Application Priority Data
Aug. 30, 2017 (EP) 17188593.2

(51) Int. Cl. H02K 1/27

(52) U.S. Cl. CPC H02K 1/2786; H02K 1/278; H02K 1/2793

(57) ABSTRACT

A multipole rotor is disclosed for an electric motor, the rotor having a rotor core and a plurality of individual permanent magnets, which are distributed over a circumference of the rotor and which, when seen in a cross-sectional view of the rotor orthogonal to an axis of the rotor, have a convex curvature on the side facing the air gap between a stator of the electric motor and the rotor. Four respective permanent magnets, which are juxtaposed in the circumferential direction of the rotor, define together a magnetic pole pair, the magnetization direction of each individual permanent magnet enclosing an angle between 30° and 60° with a reference plane extending through the axis of the rotor and through the center of the respective permanent magnet.

The present invention relates to a multipole rotor for an electric motor according to the preamble of the independent claim 1.

A rotor of this type comprises a rotor core and a plurality of individual permanent magnets, which are distributed over the circumference of the rotor and which, when seen in a cross-sectional view of the rotor orthogonal to an axis of the rotor, have a convex curvature on the side facing the air gap between a stator of the electric motor and the rotor.

A rotor according to the preamble of the independent claim 1 is known e.g. from US 20050264122 A1. In the case of this rotor, the permanent magnets are, relative to the axis of the rotor, magnetized in a radial direction. Two respective neighboring permanent magnets form a magnetic pole pair. The convex curvature of the individual permanent magnets has the advantage that detent torques are largely avoided.

It is the task of the present invention to improve a multipole rotor of the generic kind in such a way that the detent torque is reduced still further and/or the content of certain harmonics, in particular the 3^{rd} harmonic, is suppressed in delta connection.

This task is solved by the features of the independent claim 1. Accordingly, the task is solved by a solution according to the present invention in the case of a multipole rotor according to the preamble of the independent claim 1, when four respective permanent magnets, which are juxtaposed in the circumferential direction of the rotor, define together a magnetic pole pair, the magnetization direction of each individual permanent magnet being not a radial direction, but enclosing an angle α between 30° and 60° with a reference plane extending through the axis of the rotor and through the center of the respective permanent magnet.

The invention is also suitable for use with a rotor according to the preamble of the independent claim 2, which does not necessarily comprise a rotor core. Hence, the task is alternatively also solved by the features of the independent claim 2. The task is solved by a solution according to the present invention in the case of a multipole rotor according to the preamble of the independent claim 2, when four respective permanent magnets, which are juxtaposed in the circumferential direction of the rotor, define together a magnetic pole pair, the magnetization direction of each individual permanent magnet being not a radial direction, but enclosing an angle α≠0°, preferably an angle between 30° and 60°, with a reference plane extending through the axis of the rotor and through the center of the respective permanent magnet. In this case, the rotor does preferably not comprise a rotor core.

The invention offers the advantage that the detent torque is further reduced and/or the content of certain harmonics, in particular the 3^{rd} harmonic, is suppressed in delta connection. The present invention allows both goals to be aimed at. Depending on the technology used, only one goal may be aimed at, e.g. reducing only the detent torque in a grooved motor in star connection or suppressing only the 3^{rd} harmonic in a motor with ironless winding in delta connection, or both goals may be aimed at simultaneously, e.g. in a grooved motor that is to be operated in delta connection.

The individual permanent magnets are preferably evenly distributed over the circumference of the rotor. The axis of the rotor is the axis of rotation or the axis of rotational symmetry of the rotor. Further preferred, the rotor is an internal rotor, the permanent magnets being arranged on the outer circumference of the rotor. A pair of poles is defined by a group of four magnets. Every fourth permanent magnet has the same magnetization direction relative to its respective reference plane. The first two permanent magnets of a group of four define together a magnetic pole, e.g. a magnetic north pole. The third permanent magnet and the fourth permanent magnet of the group of four define together an opposite magnetic pole, e.g. a magnetic south pole. Therefore, the number of individual permanent magnets must be divisible by the number 4.

The embodiment of the present invention has a plurality of optimizable degrees of freedom: the angle of magnetization α, the air gap-side radius r of the permanent magnets, and the center of the radius of the permanent magnet can be selected freely. Furthermore, the rounding of the permanent magnet can also be chosen in a form other than a circular form and the inner contour of the permanent magnets or of the magnetic feedback element can be varied. Even if the suppression of a detent torque and of the harmonics is aimed at, not all optimizable degrees of freedom have to be used for achieving the optimization goal.

Advantageous embodiments of the present invention are the subject matter of the subclaims.

According to a preferred embodiment of the present invention, the magnetization direction of each individual permanent magnet encloses an angle between 40° and 50° with the respective reference plane. The detent torque can be avoided most effectively when the angle, which the magnetization direction of each individual permanent magnet encloses with the respective reference plane, is further preferred an angle of 45°.

Further preferred, two respective permanent magnets, which are juxtaposed in the circumferential direction of the rotor, define together a magnetic pole, the magnetization directions of these two permanent magnets being symmetric with respect to one another relative to an intermediate plane extending centrally between these two permanent magnets and through the axis of the rotor.

Further preferred, the third permanent magnet of a group of four permanent magnets following directly one after the other in a circumferential direction has, relative to the respective reference plane, a magnetization direction which is opposite to the magnetization direction of the first permanent magnet of this group of permanent magnets relative to the respective reference plane, the fourth permanent magnet of this group of permanent magnets having, relative to the respective reference plane, a magnetization direction which is opposite to the magnetization direction of the second permanent magnet of this group of permanent magnets relative to the respective reference plane.

According to a further preferred embodiment of the present invention, the permanent magnets are in contact with one another on their sides and define together an ideally closed ring. A high efficiency is accomplished in this way. Due to the repulsion between two magnets with like poles, the magnets will be distributed evenly at the circumference. The complicated positioning of the permanent magnets on the rotor core during production of the rotor is therefore no longer necessary, and this will reduce the effort as well as the cost of production.

According to a further preferred embodiment, the neighboring permanent magnets are in planar contact with one another at the respective pole transition, and the neighboring permanent magnets belonging to the same pole define a gap relative to one another or are in contact with one another, the gap having a width of less than 0.3 mm.

It will be particularly advantageous, when the side faces of the permanent magnets extend radially relative to the axis of the rotor, so that the sides of the permanent magnets are in planar contact with one another.

According to a further particularly preferred embodiment of the present invention, the convex curvature deviates from the curvature of a circle around the axis of the rotor, which circle envelops the permanent magnets directly. This embodiment allows to reduce the detent torque still further and to suppress the harmonics effectively.

For avoiding a detent torque as well as for suppressing the harmonics, it will be particularly advantageous when the radius of the convex curvature is smaller than the radius of a circle around the axis of the rotor, which circle envelops the permanent magnets directly, i.e. it envelops them at the air gap. Preferably, especially the average radius of the convex curvature is smaller than the radius of the circle around the axis of the rotor, which circle envelops the permanent magnets directly. The radius of the enveloping circle corresponds to the maximum outer diameter of the rotor, provided that the rotor is an internal rotor. Particularly preferred, the radius or the average radius of the convex curvature is between 15% and 70%, preferably between 20% and 50% of the radius of the circle around the axis of the rotor, which circle envelops the permanent magnets directly.

According to a further preferred embodiment of the present invention, the permanent magnets are fixed to one another and/or to the rotor core of the rotor by means of an adhesive. This allows the rotor according to the present invention to be produced in a particularly simple and cost-effective manner. The rotor core may either consist of a soft magnetic material, so that the rotor core represents a magnetic feedback element for the permanent magnets. Alternatively, a non-magnetic material may also be used for the rotor core.

According to a further preferred embodiment of the present invention, the rotor comprises an envelope, the permanent magnets being encompassed by the envelope on their outer side. Preferably, the magnets are connected to the envelope and/or an inner shaft by an adhesive or by a potting compound. According to another preferred embodiment of the present invention, the rotor is configured such that it comprises an envelope without a magnetic feedback element or a shaft extending therethrough.

Instead of adhesively fixing the permanent magnets to one another and/or to the rotor core or an envelope, the permanent magnets may also be fixed to the rotor core of the rotor by means of a bandage. Bandaging may also take place in addition to adhesive fixing.

According to a further embodiment of the present invention, the back of the permanent magnets positioned opposite the convexly curved side is flat. The back extends so to speak tangentially to the circumferential surface of the rotor core, provided that the rotor is an internal rotor. In the case of this embodiment, the production outlay for the permanent magnets is comparatively low.

The assembly of the rotor according to the present invention can be simplified, when the back of the permanent magnets located opposite the convexly curved side has, according to an alternative embodiment, a curvature which corresponds to the radius of the rotor core. This embodiment also provides a particularly high efficiency by optimizing the magnetic field built up by the rotor. The radius of the rotor core, to which the curvature of the back of the permanent magnets is adapted, is the outer radius of the rotor core in an internal rotor.

According to a further preferred embodiment of the present invention, the rotor may comprise a total of 8, 12 or 16 individual permanent magnets. What is decisive, however, is that the number of permanent magnets can be divided by the number 4.

According to a further embodiment of the present invention, the permanent magnets are preferably loaf-shaped in cross-section. This means that the cross-section of the permanent magnets comprises a base, two sides extending obliquely thereto and diverging from each other from the base, as well as a convexly curved outer side opposite the base. The two sides of the cross-section extend preferably radially with respect to the axis of the rotor.

According to an alternative but nevertheless preferred embodiment, the permanent magnets have the shape of a piece of cake in cross-section. This means that, in comparison with the loaf-shaped embodiment, the base of the cross-section is either shorter than the two sides or the cross-section has no base at all. The two sides of the cross-section extend obliquely to each other also in this case and define, together with the convexly curved outer side, the shape of a piece of cake.

Further preferred, all the permanent magnets have the same geometry and are further preferred each symmetric to their own reference plane.

The invention also provides an electric motor with a stator and a rotor according to the present invention. The rotor may here be configured according to one or a plurality of the above described embodiments.

Embodiments of the present invention are explained hereinafter with reference to the drawings, in which

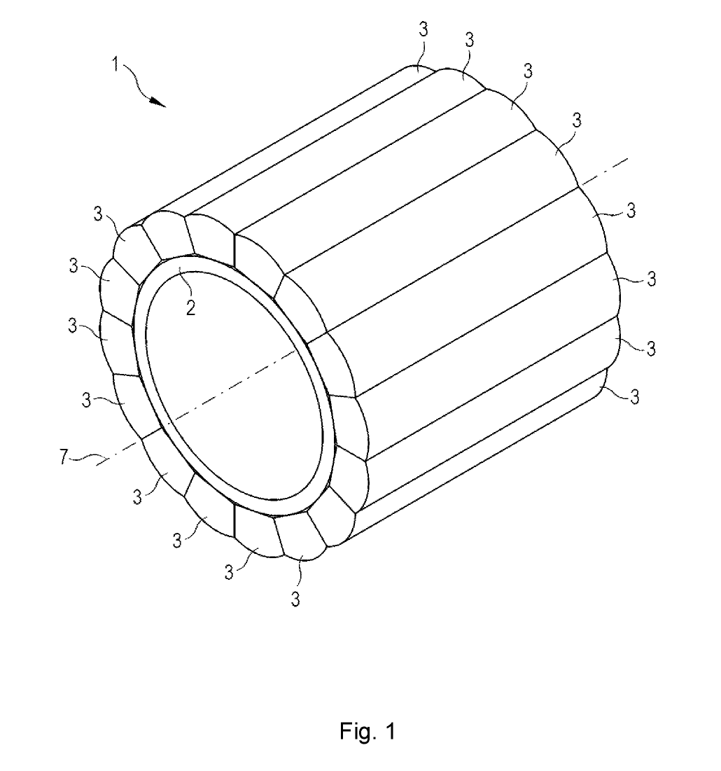

FIG. 1 shows an oblique view of a multipole rotor according to a first embodiment of the present invention,

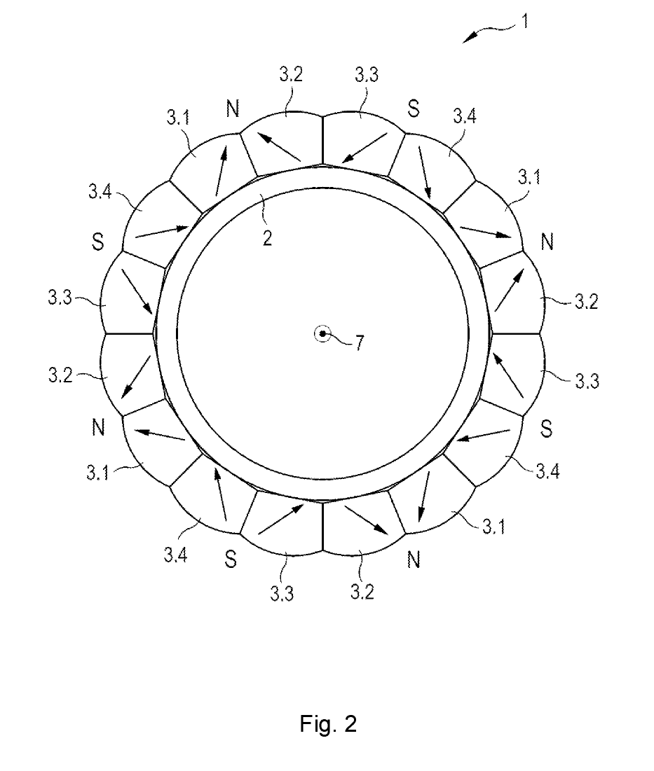

FIG. 2 shows a cross-section through the rotor according to the present invention as disclosed in FIG. 1,

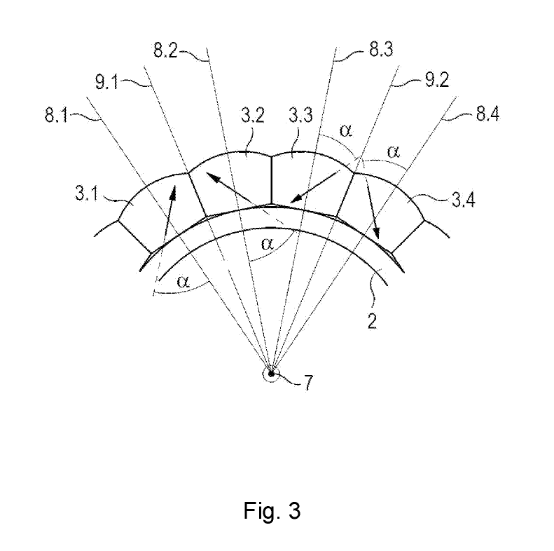

FIG. 3 shows a detail view of the representation according to FIG. 2,

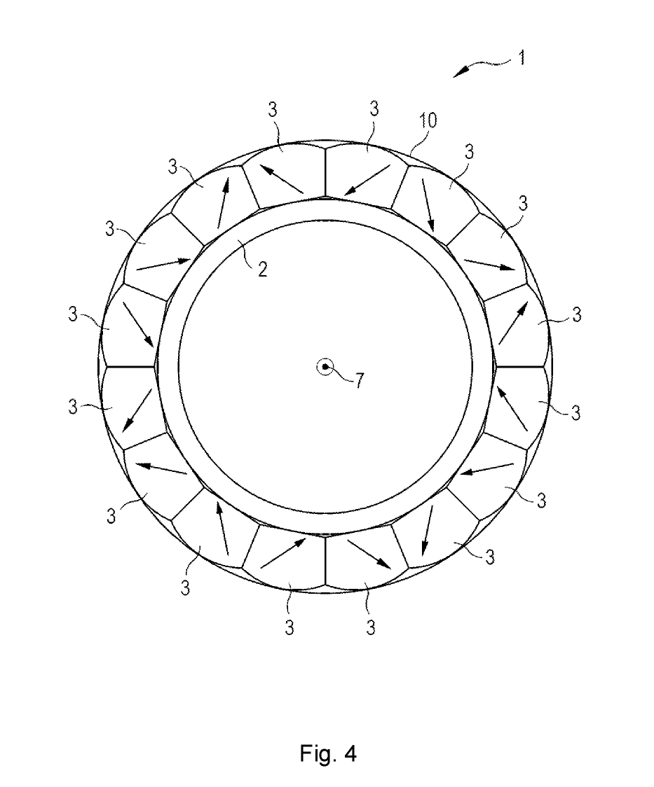

FIG. 4 shows, in a cross-sectional view, a modification of the multipole rotor according to the present invention as disclosed in FIGS. 1 to 3,

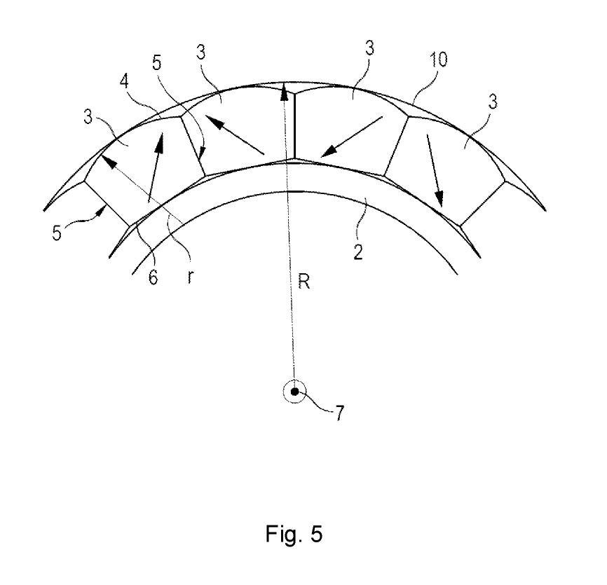

FIG. 5 shows a detail view of the representation according to FIG. 4,

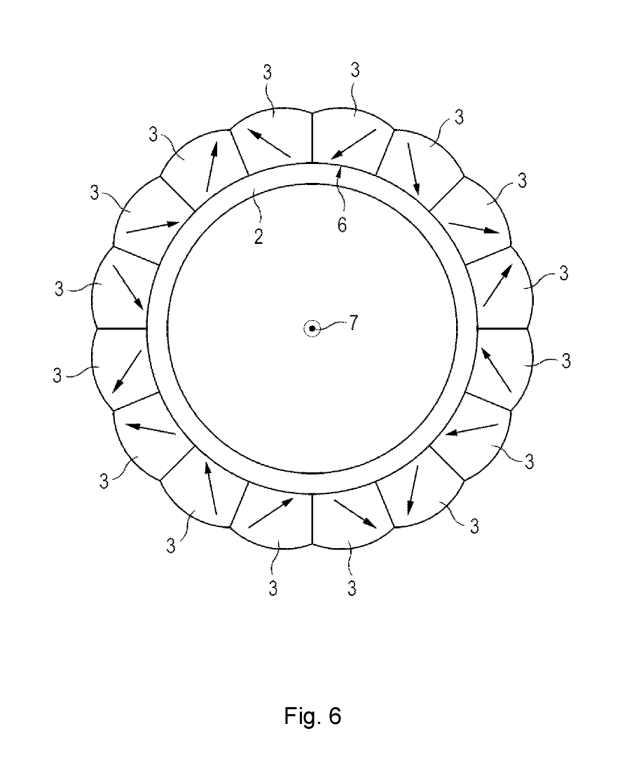

FIG. 6 shows a cross-section through a multipole rotor according to a further embodiment of the present invention,

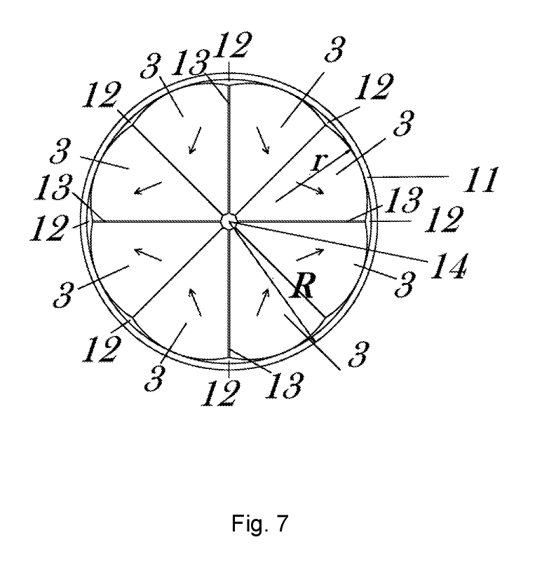

FIG. 7 shows a cross-section through a multipole rotor comprising an envelope and piece-of-cake-like permanent magnets, the rotor comprising neither a rotor core nor a shaft,

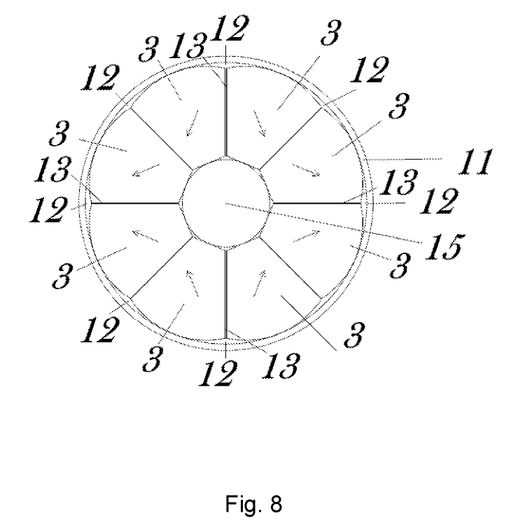

FIG. 8 shows a cross-section through a multipole rotor with an envelope and piece-of-cake-like to loaf-shaped permanent magnets, with a shaft extending through the interior of the rotor,

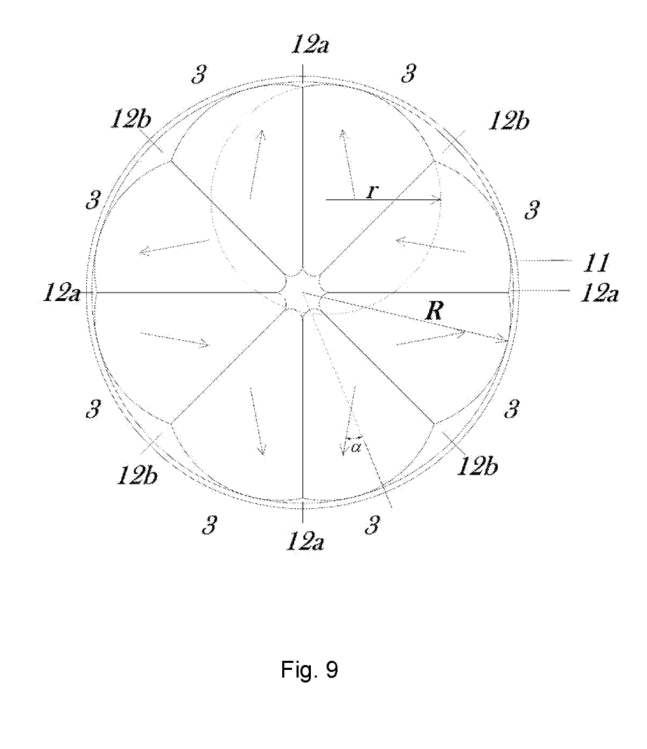

FIG. 9 shows a cross-section through a multipole rotor in which the center of the circle of the outer contour of the permanent magnets is not symmetric, and

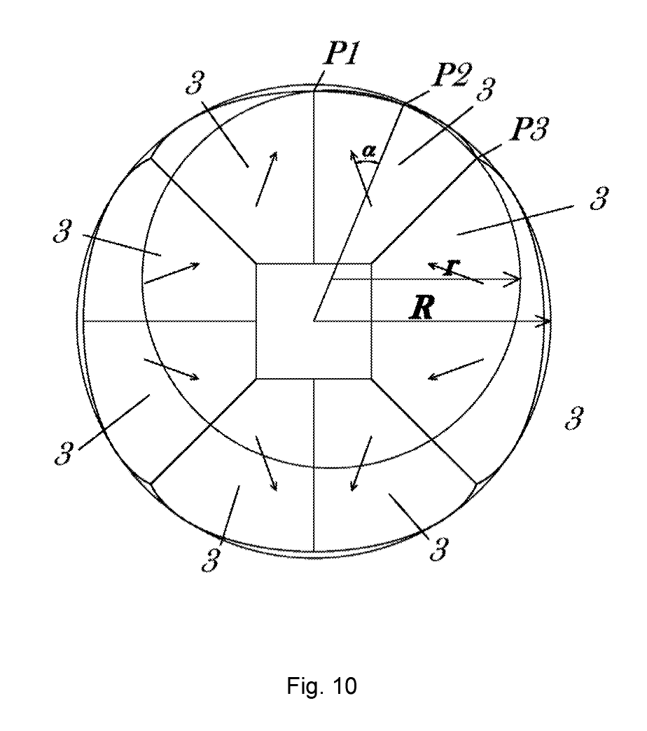

FIG. 10 shows a cross-section through a multipole rotor in which the outer contour of the permanent magnets does not correspond to a segment of a circle.

As regards the statements made hereinafter, like parts will be designated with like reference numerals. If a figure comprises reference numerals that are not discussed in detail in the associated description of the figure, preceding or subsequent descriptions of the figures will be referred to.

FIG. 1 shows a first embodiment of a multipole rotor 1 according to the present invention in an oblique view. The rotor 1 comprises a rotor core 2 as well as a plurality of substantially rod-shaped permanent magnets 3, which are arranged such that they are evenly distributed over the circumference of the rotor core. In the embodiment shown, a total of 16 individual permanent magnets 3 is provided. The axis of the rotor is designated with reference numeral 7 in the figures.

As can especially be seen from FIG. 2, the permanent magnets, have a convex curvature on the outer side, when seen in a cross-sectional view orthogonal to the axis 7 of the rotor. The permanent magnets are here loaf-shaped in cross-section. Four respective neighboring permanent magnets, i.e. permanent magnets following one another in the circumferential direction of the rotor, define together a magnetic pole pair of the rotor. The first permanent magnet 3.1 and the second permanent magnet 3.2 of such a group of four define together a magnetic north pole N of the rotor. The third permanent magnet 3.3 and the fourth permanent magnet 3.4 of each group of four define together a magnetic south pole S.

FIG. 3 shows a detail view of the cross-section according to FIG. 2. This detail view shows a group of four permanent magnets. Each permanent magnet has assigned thereto a reference plane 8, which extends through the axis 7 of the rotor and through the center of the respective permanent magnet. The reference plane of the first permanent magnet 3.1 is designated with reference numeral 8.1. The reference plane of the second permanent magnet 3.2 is designated with reference numeral 8.2. The reference plane of the third permanent magnet 3.3 is designated with reference numeral 8.3. And the reference plane of the fourth permanent magnet 3.4 is designated with reference numeral 8.4. The magnetization direction of each individual permanent magnet encloses an angle α of 45° with the respective reference plane of the permanent magnet. The directions of magnetization of the first permanent magnet 3.1 and of the second permanent magnet 3.2 are symmetric with respect to one another relative to an intermediate plane 9.1 extending centrally between these two permanent magnets and through the axis 7 of the rotor. Likewise, also the magnetization directions of the third permanent magnet 3.3 and the fourth permanent magnet 3.4 are symmetric with respect to one another relative to a second intermediate plane 9.2 extending centrally between the permanent magnets 3.3 and 3.4 and through the axis 7 of the rotor. Furthermore, it can be seen that the third permanent magnet 3.3 has, relative to its reference plane 8.3, a magnetization direction which is opposite to the magnetization direction of the first permanent magnet 3.1 relative to the reference plane 8.1. The fourth permanent magnet 3.4 has, relative to its reference plane 8.4, a magnetization direction which is opposite to the magnetization direction of the second permanent magnet relative to the reference plane 8.2.

In the embodiment according to FIGS. 1 to 3, the permanent magnets are secured to one another and to the rotor core 2 of the rotor by means of an adhesive. FIG. 4 shows a modification provided, either additionally or alternatively, with a bandage 10 by means of which the permanent magnets 3 are fixed to the rotor core 2. As can be seen from FIG. 5, the bandage has a radius R, relative to the axis 7 of the rotor, which essentially corresponds to the radius of a circle that envelops the permanent magnets 3 on the outer circumference of the rotor.

In FIG. 5 it can also be seen that the radius r of the convex curvature on the outer side 4 of the permanent magnets is significantly smaller than the external radius R of the rotor. In the embodiments shown in FIGS. 1 to 6, the ratio between the radius r and the radius R is approximately 1/3. Furthermore, in all the embodiments shown, the side faces 5 of the permanent magnets 3 are configured such that they extend radially relative to the axis 7 of the rotor, so that the sides of the permanent magnets 3 are in planar contact with one another.

In the embodiments according to FIGS. 1 to 5, the lower surface 6 of the respective permanent magnets 3 is flat. Hence, it extends tangentially to the circumferential surface of the rotor core 2. FIG. 6, however, shows an embodiment in the case of which the lower surface 6 of the permanent magnets 3 has a curvature whose radius is adapted to the radius of the outer circumference of the rotor core 2, so that the permanent magnets 3 are in intimate contact with the outer circumference of the rotor core.

FIG. 7 shows a cross-section through a four-pole rotor according to a further embodiment with eight piece-of-cake-like permanent magnets 3, which are introduced in an envelope 11. The free spaces 12 between the permanent magnets and the envelope 11, the gaps 13 between the permanent magnets 3, and the interior 14 are fully or partly filled with an adhesive or a potting compound. The torque is transmitted via the envelope and/or the end faces of the permanent magnets, since the present embodiment uses neither a rotor core nor a shaft. The ratio between the radius r of the outer contour of the permanent magnet and the radius R of the circle, which encompasses the magnets in their entirety and which corresponds approximately to the inner diameter of the envelope, is approx. 2/3.

FIG. 8 shows a modification of the embodiment according to FIG. 7. Also this representation shows a cross-section through a four-pole rotor with eight piece-of-cake-like permanent magnets 3, which have been introduced in an envelope 11. The rotor comprises, in addition to the envelope 11, also a shaft 15.

FIG. 9 shows a cross-section through another rotor according to the present invention, in which the centers of the circle of the outer contour of the permanent magnets are not symmetric, the magnet height at the poles 12a being thus different from that at the pole transitions 12b. The angle α is only 32°. The ratio between the radius of the outer contour of the permanent magnets r and the radius R of the circle enveloping the magnets in their entirety is approx. 1/2.

FIG. 10 shows a cross-section of a further rotor according to the present invention, in the case of which two further degrees of freedom are used: the outer contour of the permanent magnets deviates from the circular shape. The average radius r of the non-circular contour is determined by the circle passing through the three points P1, P2, P3. Points P1 and P3 are determined by the two corners of the cross-section; point P2 is at the center of the permanent magnet, defined by the intersection of the outer contour and the perpendicular bisector of the distance from P1 to P3. For the inner contour, a square has been chosen. The angle α is 42°.

1. A multipole rotor for an electric motor, the rotor comprising:
a rotor core; and
a plurality of individual permanent magnets which are distributed over a circumference of the rotor and which, when seen in a cross-sectional view of the rotor orthogonal to an axis of the rotor, have a convex curvature on a side facing an air gap to be located between a stator of the electric motor and the rotor, wherein four respective permanent magnets which are juxtaposed in a circumferential direction of the rotor, define together a magnetic pole pair (N, S), a magnetization direction of each individual permanent magnet enclosing an angle (α) between 30° and 60° with a reference plane extending through the axis of the rotor and through a center of a respective permanent magnet.

2. A multipole rotor for an electric motor, the rotor comprising:
a plurality of individual permanent magnets, which are distributed over a circumference of the rotor and which, when seen in a cross-sectional view of the rotor orthogonal to an axis of the rotor, have a convex curvature on a side facing an air gap to be located between a stator of the electric motor and the rotor, wherein four respective permanent magnets, which are juxtaposed in a circumferential direction of the rotor, define together a magnetic pole pair (N, S), a magnetization direction of each individual permanent magnet enclosing an angle (α)≠0°, with a reference plane extending through the axis of the rotor and through a center of a respective permanent magnet.

3. The rotor according to claim 2, wherein the rotor does not have a rotor core.

4. The rotor according to claim 1, wherein the magnetization direction of each individual permanent magnet encloses an angle (α) between 40° and 50° with the respective reference plane.

5. The rotor according to claim 1, wherein two respective, permanent magnets, which are juxtaposed in the circumferential direction of the rotor, define together a magnetic pole (N, S), magnetization directions of these two permanent magnets being symmetric with respect to one another relative to an intermediate plane extending centrally between these two permanent magnets and through the axis of the rotor.

6. The rotor according to claim 1, wherein a third permanent magnet of a group of the four permanent magnets following directly one after the other in a circumferential direction has, relative to the respective reference plane, a magnetization direction which is opposite to the magnetization direction of a first permanent magnet of this group of permanent magnets relative to the respective reference plane, the fourth permanent magnet of this group of permanent magnets having, relative to the respective reference plane, a magnetization direction which is opposite to the magnetization direction of a second permanent magnet of this group of permanent magnets relative to the respective reference plane.

7. The rotor according to claim 1, wherein neighboring permanent magnets are in planar contact with one another at a respective pole transition, and the neighboring permanent magnets belonging to a same pole define a gap relative to one another or are in contact with one another, the gap having a width of less than 0.3 mm.

8. The rotor according to claim 7, wherein the side faces of the permanent magnets extend radially relative to the axis of the rotor.

9. The rotor according to claim 1, wherein the convex curvature deviates from a curvature of a circle around the axis of the rotor, the circle enveloping the permanent magnets directly.

10. The rotor according to claim 9, wherein an average radius (r) of the convex curvature is smaller than a radius (R) of the circle around the axis of the rotor, which circle envelops the permanent magnets directly.

11. The rotor according to claim 9, wherein an average radius (r) of the convex curvature is between 15% and 70% of a radius (R) of the circle around the axis of the rotor, which circle envelops the permanent magnets directly.

12. The rotor according to claim 1, wherein the permanent magnets are fixed to one another and/or to the rotor core of the rotor by an adhesive.

13. The rotor according to claim 1, wherein the rotor comprises:
an envelope, the permanent magnets being encompassed by the envelope on their outer side.

14. The rotor according to claim 13, wherein the permanent magnets are connected to the envelope by an adhesive or by a potting compound.

15. The rotor according to claim 1, wherein the permanent magnets are fixed to the rotor core of the rotor by a bandage.

16. The rotor according to claim 1, wherein a back of the permanent magnets positioned opposite the convexly curved side is flat.

17. The rotor according to claim 1, wherein a back of the permanent magnets positioned opposite the convexly curved side has a curvature which corresponds to the radius of the rotor core.

18. The rotor according to claim 1, wherein the permanent magnets are loaf-shaped in cross-section.

19. The rotor according to claim 2, wherein the permanent magnets have a shape of a piece of cake in cross-section.

20. The according to one of the claim 2, wherein the angle is between 30° and 60°.
